(19) United States
(12) Patent Application Publication
(10) Pub. No.: US 2016/0100528 A1
(43) Pub. Date: Apr. 14, 2016

(54) LIGHTING SYSTEM FOR PLANT CULTIVATION

(71) Applicant: Albert CHOW, New Taipei City (TW)

(72) Inventor: Albert CHOW, New Taipei City (TW)

(21) Appl. No.: 14/510,432

(22) Filed: Oct. 9, 2014

(51) Int. Cl. A01G 7/04; F21V 29/89; F21V 23/02

(52) U.S. Cl. CPC A01G 7/045; F21V 23/026; F21V 29/89; F21Y 2101/02

(57) ABSTRACT

A lighting system for plant cultivation which is established on a planting system planted with a plurality of plants is provided. The lighting system includes an illumination module and a ring transformer module. The illumination module includes a plurality of light emitting units and a power connection port. Each of the light emitting units includes a plurality of light emitting diodes (LEDs) that emit light towards the plants when powered. The ring transformer module includes a ring core, a primary coil winding around the ring core, and a secondary coil winding around the ring core. A non-harmonic power is provided by the one single ring transformer module for powering the light emitting units, thereby solving issues of power consumption and heat dissipation caused by conventionally disposing an electronic rectifier in every of the light emitting units.

### FIELD OF THE INVENTION

The present invention relates to a lighting system, and particularly to a lighting system for plant cultivation installed with a ring transformer module.

### BACKGROUND OF THE INVENTION

As illumination applications of light emitting diodes (LEDs) mature, some plant factory industrialists apply such technology to plant cultivation. However, an LED lamp applied to plant cultivation usually includes a circuit board disposed with a plurality of LEDs and an electronic rectifier installed on the circuit board. In an application process, the electronic rectifier transforms a received external alternating current (AC) power to a direct current (DC) power, and sends the DC power to each of the LEDs to cause the LED to illuminate. A reason for installing the electronic rectifier in the LED lamp is to provide the LEDs with a stable DC power during the illumination process of the LEDs. Due to a large volume of the electronic rectifier, the electronic rectifier occupies a large portion of the internal space of the LED lamp. As a result, heat dissipation in the LED lamp may be unsatisfactory and internal components are liable to damages under a long-term use, such that the LED lamp may fail to functionally provide the power required for plant cultivation.

In addition, a current power supply of a plant factory is mainly from a large electricity room, in which a plurality of transformers and a plurality of power converters that are connected to an external high-voltage power are installed. After multi-stage down-conversion processes performed by the transformers and the power converters, the original external high-voltage power is transformed to a lower-voltage power applicable and outputted to each of the LEDs. During the multi-stage down-conversion processes, an excessive amount of wear is generated with respect the large electricity room. Moreover, in the large electricity room, the transformers and power converters may be installed too closely to one another, resulting in not only difficulties in maintenance and inspection procedures of the maintenance staff but also strange noises that prohibit the maintenance staff from coming near these transformers and power converters.

### SUMMARY OF THE INVENTION

The primary object of the present invention is to solve issues of heat dissipation and power consumption caused by the built-in electronic rectifier in a conventional light emitting diode (LED) lamp.

To achieve the above object, the present invention provides a lighting system for plant cultivation established on a planting system planted with a plurality of plants. The lighting system for plant cultivation includes an illumination module, and a ring transformer module connected to the illumination module. The illumination module includes a seat, and a plurality of light emitting units disposed on the seat. Each of the light emitting units includes a plurality of LEDs that emit light towards the plants when powered, and a power connection port electrically connected to the LEDs. The ring transformer module includes a ring core, a primary coil winding around the ring core and connected to an external power source to receive an external power, and a secondary coil winding around the ring core and electrically connected to the power connection ports. The primary coil and the secondary coil form magnetic coupling to output power to the LEDs via the respective power connection ports.

Further, each of the LEDs includes a circuit board arranged with the LEDs.

Further, each of the LEDs includes a reflecting layer disposed at one side of the circuit board arranged with the LEDs.

Further, each of the LEDs includes a heat dissipation seat disposed at one side of the circuit board opposite to the side arranged with the LEDs.

Further, the heat dissipation seat is a rectangular tube.

Further, the seat is made of a metal material having a preferred heat dissipation coefficient.

Further, the external power source is a high-voltage alternating current (AC) power.

Further, the power connection port includes at least two power connection terminals, and an insulation cover coating the power connection terminals.

Further, the ring transformer module includes a first insulation casing and a second insulation casing that separate the primary coil and the secondary coil when correspondingly covered to each other.

Compared a conventional solution, the structure disclosed by the present invention has following features.

1. In the present invention, one single ring transformer module provides the plurality of light emitting units with power required for illumination, hence solving issues of heat dissipation and power consumption caused by disposing an electronic rectifier in each of the light emitting units.

2. In the present invention, as the electronic rectifier or the ring transformer module is not included in each of the light emitting units, production costs are reduced.

3. In the present invention, only a one-time transformation process performed by the ring transformer module is involved, such that the maintenance staff can more easily carry out maintenance.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic diagram according to a preferred embodiment of the present invention;

FIG. 2 is a schematic diagram of operations according to a preferred embodiment of the present invention;

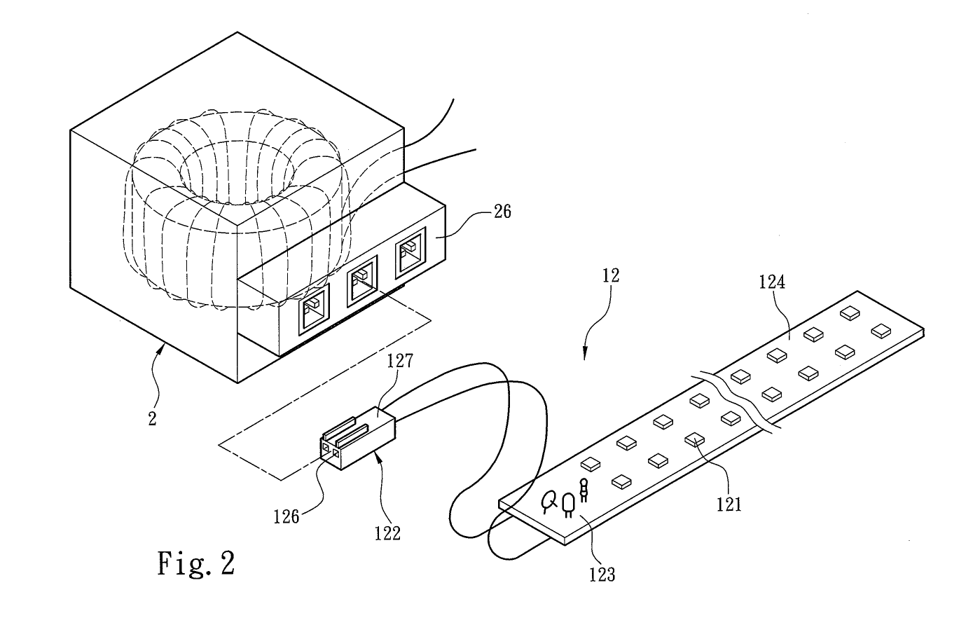

FIG. 3 is a schematic diagram of a ring transformer of the present invention; and

FIG. 4 is a schematic diagram according to another embodiment of the present invention.

### DETAILED DESCRIPTION OF THE PREFERRED EMBODIMENTS

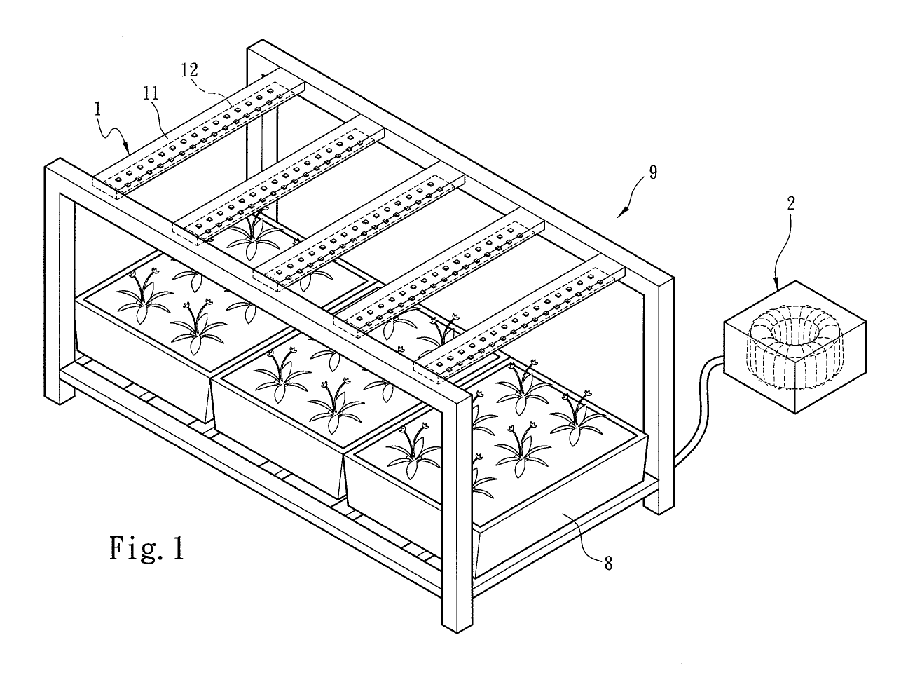

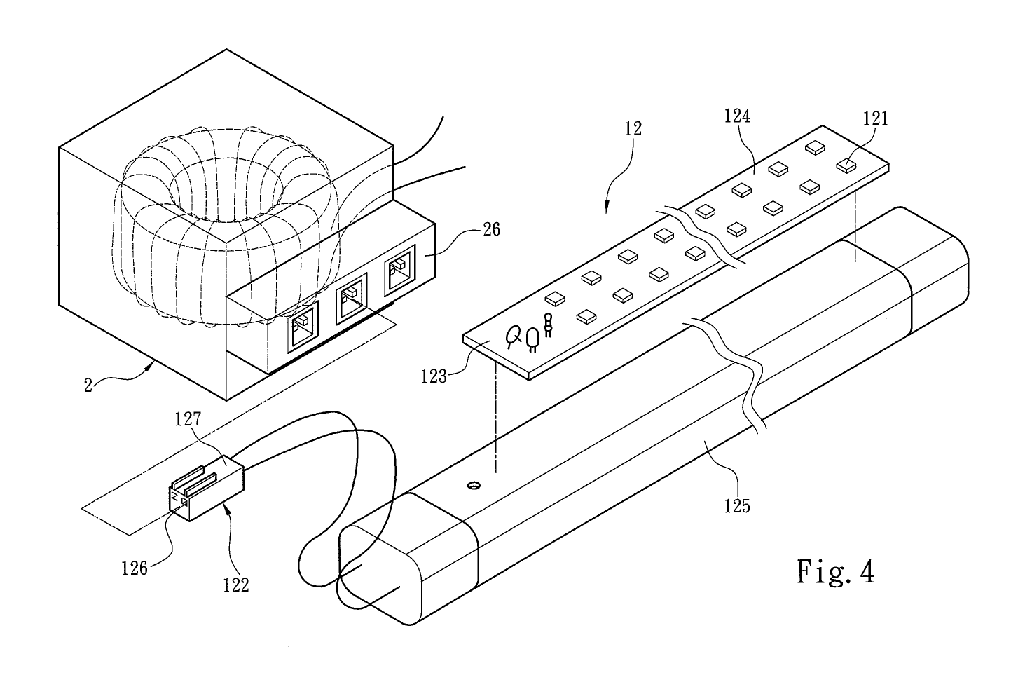

Referring to FIG. 1, the present invention discloses a lighting system 9 established on a planting system 8 planted with a plurality of plants. The lighting system 9 includes an illumination module 1 and a ring transformer module 2. The illumination module 1 includes a seat 11, and a plurality of light emitting units 12 disposed on the seat 11. More specifically, the seat 11 of the present invention may be implemented in two forms. The seat may be implemented as a plate structure as shown in FIG. 1, or may be a frame structure. For both of the above implementation forms, the light emitting units 12 may be directly assembled to the seat 11. Further, the seat 11 may be made of a metal material having a preferred heat dissipation coefficient, e.g., copper and aluminum. Further, instead of carrying only one light emitting unit 12 as shown in FIG. 1, the seat 11 of the present invention is also capable of carrying a plurality of light emitting units 12. Thus, when the illumination module 1 illuminates, the seat 11 may collect waste heat generated by each of the light emitting units 12. When the lighting system 9 of the present invention is applied in a cold climate, the seat 11 may collect the waste heat generated by the light emitting units 12 for a heating purpose. Referring to FIG. 4, each of the light emitting units 12 includes a plurality of light emitting diodes (LEDs) 121 that emit light towards the plants when powered, and a power connection port 122 electrically connected to the LEDs 121. More specifically, each of the light emitting units 12 includes a circuit board 123 arranged with the LEDs 121, a reflecting layer 124 disposed at one side of the circuit board 123 arranged with the LEDs 121, and a heat dissipation seat 125 disposed at one side of the circuit board 123 opposite the side arranged with the LEDs 121. The reflecting layer 124 is for reflecting light from the LEDs 121, and may be arranged at one side disposed with the LEDs 121 by a chemical means such as sputtering or a physical means such as applying. Further, the heat dissipation heat 125 mainly serves for drawing the waste heat generated during the illumination process of the LEDs 121, and may also serve as a heating element in a cold environment. The power connection portion 122 of the present invention includes at least two power connection terminals 126 and an insulation cover 127 coating the power connection terminals 126, as shown in FIG. 4. In an application, in addition to being electrically connected to the LEDs 121, the power connection portion 122 is further electrically connected to the ring transformer module 2 to obtain a modulated power from the ring transformer module 2.

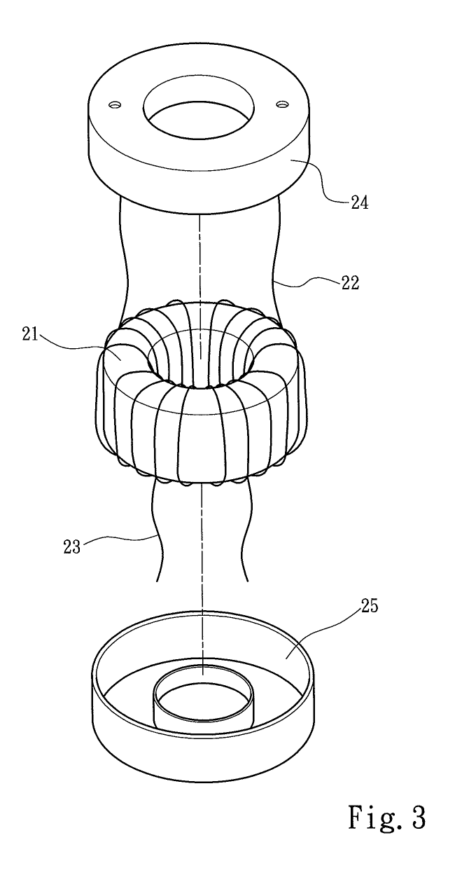

Referring to FIG. 3 and FIG. 4, the ring transformer module 2, connected to the illumination module 1 and an external power, includes a ring core 21, a primary coil 22 winding around the ring core 21 and connected to an external power source, and a secondary coil 23 winding around the ring core 21 and electrically connected to the power connection ports 122. The ring transformer module 2 further includes a first insulation casing 24 and a second insulation casing 25 that separate the primary coil 22 and the secondary coil 23 when the first insulation casing 24 and the second insulation casing 25 are correspondingly covered to each other. The ring transformer module 2 further includes a power connection socket 26. The power connection socket 26 is electrically connected to the secondary coil 23 and inserted by the power connection ports 122.

As shown in FIG. 4, in an embodiment of the present invention, the primary coil 22 of the ring transformer module 2 is connected to an external power source to receive an external power, e.g., a high-voltage or ultra-high-voltage alternating current (AC) power such as an ultra-high-voltage in a kilovolt-amp (kVA) level. Magnetic coupling is formed by the primary coil 22 and the secondary coil 23 to convert the external power to a direct current (DC) power applicable to operations of the illumination module 1 and outputted to the illumination module 1. Via the power connection ports 122, the DC power is outputted to each of the light emitting units 12 to power the LEDs 121 of the light emitting unit 12 and to cause the LEDs 121 to emit light towards the plants.

In conclusion, a non-harmonic power is provided by a single ring transformer module to each of the light emitting units, thereby solving issues of power loss and unsatisfactory heat dissipation caused by individually providing the light emitting units with respective electronic rectifiers.

What is claimed is:

1. A lighting system for plant cultivation, established on a planting system planted with a plurality of plants, the lighting system for plant cultivation, comprising:
an illumination module, comprising a seat and a plurality of light emitting units; each of the plurality of light emitting units comprising a plurality of light emitting diodes (LEDs) that emit light toward the plants when powered, and a power connection portion electrically connected to the LEDs; and
a ring transformer module, connected to the illumination module, comprising a ring core, a primary coil winding around the ring core and connected to an external power source to receive an external power, and a secondary coil winding around the ring core and electrically connected to the power connection ports; the primary coil and the secondary coil forming magnetic coupling to output a non-harmonic power to the LEDs via the respective power connection ports.

2. The lighting system for plant cultivation of claim 1, wherein each of the light emitting units comprises a circuit board arranged with the LEDs.

3. The lighting system for plant cultivation of claim 2, wherein each of the light emitting units comprises a reflecting layer disposed at one side of the circuit board arranged with the LEDs.

4. The lighting system for plant cultivation of claim 2, wherein each of the light emitting units comprises a heat dissipation seat disposed at one side of the circuit board opposite the side arranged with the LEDs.

5. The lighting system for plant cultivation of claim 4, wherein the heat dissipation seat is a rectangular tube.

6. The lighting system for plant cultivation of claim 1, wherein the seat is made of a metal material having a preferred heat dissipation coefficient.

7. The lighting system for plant cultivation of claim 1, wherein the external power source is a high-voltage alternating current (AC) power.

8. The lighting system for plant cultivation of claim 1, wherein each of the power connection ports comprise at least two power connection terminals and an insulation cover coating the power connection terminals.

9. The lighting system for plant cultivation of claim 1, wherein the ring transformer module comprises a first insulation casing and a second insulation casing that separate the primary coil and the secondary coil when correspondingly covered to each other.
